(19) United States
(12) Patent Application Publication
(10) Pub. No.: US 2008/0191842 A1
(43) Pub. Date: Aug. 14, 2008

(54) Systems and Methods for Managing Objects

(75) Inventors: John Spenik, Phoenix, AZ (US); Brian Woodbury, Gilbert, AZ (US); Roc Lastinger, Cave Creek, AZ (US)

Correspondence Address: LETHAM LAW FIRM, LLC, 914 N. TUCANA LANE, GILBERT, AZ, 85234, US

(73) Assignee: Quixcode, LLC, Scottsdale, AZ (US)

(21) Appl. No.: 12/027,235

(22) Filed: Feb. 6, 2008

Related U.S. Application Data
(60) Provisional application No. 60/900,143, filed on Feb. 8, 2007.
(60) Provisional application No. 60/905,522, filed on Mar. 7, 2007.
(60) Provisional application No. 60/943,098, filed on Jun. 11, 2007.
(60) Provisional application No. 60/968,400, filed on Aug. 28, 2007.
(60) Provisional application No. 61/019,127, filed on Jan. 4, 2008.

(51) Int. Cl. H04Q 5/22

(52) U.S. Cl. 340/10.1

(57) ABSTRACT

Systems and methods for managing objects that include providing a carrier, using one or more tags to modulate the carrier to produce a modulated carrier, transmitting the modulated carrier to a reader through a conductor or wirelessly. All tags are coupled to a first conductor.

### CROSS-REFERENCE TO RELATED APPLICATIONS

This application claims benefit under 35 U.S.C. § 119(e) of U.S. Provisional Application No. 60/900,143 filed Feb. 8, 2007, U.S. Provisional Application No. 60/905,522 filed Mar. 7, 2007, U.S. Provisional Application No. 60/943,098 filed Jun. 11, 2007, U.S. Provisional Application No. 60/968,400 filed Aug. 28, 2007, and U.S. Provisional Application No. 61/019,127 filed Jan. 4, 2008. All above applications are herein incorporated by reference.

### FIELD OF THE INVENTION

Embodiments of the present invention relate to systems and methods for identifying, tracking, and/or monitoring objects and methods for performing operations in accordance with identifying, tracking, and/or monitoring objects.

### BACKGROUND OF THE INVENTION

Convention systems for identifying, tracking, and/or monitoring objects (e.g., RFID, barcode) generally employ a bidirectional communication between a reader and the object. Bidirectional communication permits a reader to individually address (e.g., select) and communicate with a single object. Bidirectional communication increases cost and complexity of a system. Furthermore, conventional systems perform poorly when attempting to communicate with the objects in close physical proximity. A system that uses one-way communication from a plurality of objects to a reader and improves identification of objects in close physical proximity may benefit from decreased cost and increased reliability of performance.

### SUMMARY OF THE INVENTION

A system, according to various aspects of the present invention, that receives information from an object. The system includes at least one tag, a first conductor, a carrier generator, and a reader. Each one tag mechanically couples to a respective object. The first conductor electrically couples to each tag. The carrier generator electrically couples to the first conductor. The reader electrically couples to the first conductor. Each one tag stores its respective information. The carrier generator provides a carrier to the first conductor. Each tag modulates the carrier in accordance with its respective information thereby producing a modulated carrier. The reader receives the modulated carrier through the first conductor thereby receiving the information from each tag respectively. The reader does not modulate the carrier.

A system, according to various aspects of the present invention, that receives information from an object. The system includes at least one tag, a first conductor, a carrier generator, and a reader having an antenna. Each one tag mechanically couples to a respective object. The first conductor electrically couples to each tag. The carrier generator electrically couples to the first conductor. Each one tag stores its respective information. The carrier generator provides a carrier to the first conductor. Each tag modulates the carrier in accordance with its respective information thereby producing a modulated carrier. The first conductor radiates the modulated carrier as an RF signal. The reader wirelessly receives the modulated carrier through the antenna thereby receiving the information from each tag respectively. The reader does not modulate the carrier.

A system, according to various aspects of the present invention, that receives information from an object. The system includes at least one tag, a first conductor, a carrier generator having an antenna, and a reader having an antenna. Each one tag mechanically couples to a respective object. The first conductor electrically couples to each tag. Each one tag stores its respective information. The antenna of the carrier generator transmits a carrier as an RF signal to the first conductor. Each tag modulates the carrier in accordance with its respective information thereby producing a modulated carrier. The first conductor radiates the modulated carrier as an RF signal. The reader wirelessly receives the modulated carrier through the antenna thereby receiving the information from each tag respectively. The reader does not modulate the carrier.

A system, according to various aspects of the present invention, that receives information from an object. The system includes a plurality of tags, a power supply, and a reader having an antenna. Each tag has a respective antenna and a respective carrier generator that provides a respective carrier. Each one tag mechanically couples to a respective object. The power supply provides an electric potential to the plurality of tags. Each one tag stores its respective information. Each tag modulates the carrier in accordance with its respective information thereby producing a modulated carrier. Each tag wirelessly transmits its respective modulated carrier as a respective RF signal using its respective antenna. The reader wirelessly receives each respective RF signal through the antenna of the reader thereby receiving the information from each tag respectively.

A system, according to various aspects of the present invention, that receives information from an object. The system includes at least one tag, a first conductor, a carrier generator, and a reader having an antenna and a contact. Each one tag mechanically couples to a respective object. The first conductor electrically couples to each tag. The carrier generator electrically couples to the first conductor. Each one tag stores its respective information. The carrier generator provides a carrier to the first conductor. Each tag modulates the carrier in accordance with its respective information thereby producing a modulated carrier. The first conductor radiates the modulated carrier as an RF signal. the reader receives the modulated carrier through the contact while the contact is mechanically and electrically coupled to the first conductor; and through the antenna while the contact is not mechanically and electrically coupled to the first conductor. The reader does not modulate the carrier.

A system, according to various aspects of the present invention, that receives information from an object. The system includes at least one tag, a first conductor, a carrier generator having an antenna, and a reader. Each one tag mechanically couples to a respective object. The first conductor electrically couples to each tag. The reader electrically couples to the first conductor. Each one tag stores its respective information. The antenna of the carrier generator transmits a carrier as an RF signal to the first conductor. Each tag modulates the carrier in accordance with its respective information thereby producing a modulated carrier. The reader receives the modulated carrier through the first conductor thereby receiving the information from each tag respectively. The reader does not modulate the carrier.

A method, according to various aspects of the present invention, for transmitting a respective information from a plurality of tags to a reader. A system performs the method. The method includes in any practical order, providing a carrier to a first conductor; modulating the carrier using the plurality of tags to produce a modulated carrier; and conducting the modulated carrier through the first conductor to the reader. Each one tag modulates the carrier in accordance with its respective information. Each one tag electrically couples to the first conductor.

A method, according to various aspects of the present invention, for transmitting a respective information from a plurality of tags to a reader. A system performs the method. The method includes in any practical order, providing a carrier to a first conductor; modulating the carrier using the plurality of tags to produce a modulated carrier; and radiating the modulated carrier from the first conductor as an RF signal to the reader. Each one tag modulates the carrier in accordance with its respective information. Each one tag electrically couples to the first conductor.

### BRIEF DESCRIPTION OF THE DRAWING

Embodiments of the present invention will now be further described with reference to the drawing, wherein like designations denote like elements, and:

FIG. 1 is a functional block diagram of a system, according to various aspects of the present invention, having a reader that receives through a conductor;

FIG. 2 is a functional block diagram of a system, according to various aspects of the present invention, having a reader that receives an RF signal radiated by a conductor;

FIG. 3 is a functional block diagram of a system, according to various aspects of the present invention, that provides a carrier wirelessly and has a reader that receives an RF signal radiated by a conductor;

FIG. 4 is a functional block diagram of a system, according to various aspects of the present invention, having a reader that receives an RF signal radiated by a plurality of tags that have a common source of power;

FIG. 5 a plan view of the system of FIGS. 1-4 in an implementation for a filing system;

FIG. 6 a top plan view of the system of FIG. 5;

FIG. 7 a close-up plan view of a rail and a hook of system of FIG. 5;

FIG. 8 a schematic diagram of a directional device for the systems of FIGS. 1-4;

FIG. 9 a schematic diagram of a directional device for the systems of FIGS. 1-4;

FIG. 10 a top plan view of a segmented rail for a the system of FIGS. 5-7;

FIG. 11 is a plan view of the system of FIGS. 1-4 implemented for a card system;

FIG. 12 is a plan view of keyed card for the card of system FIG. 11;

FIG. 13 is a perspective plan view of a peg board for the system of FIG. 16;

FIG. 14 is a side plan view of a peg board for the system of FIG. 16;

FIG. 15 is a side plan view of a hook for the system of FIG. 16;

FIG. 16 is a perspective plan view of the system of FIGS. 1-4 implemented for a peg board;

FIG. 17 is a perspective plan view of the system of FIGS. 1-4 implemented for a peg board;

FIG. 18 is a schematic of the system of FIGS. 1-4 implemented for a peg board;

FIG. 19 is a perspective plan view of a hook of FIG. 20;

FIG. 20 is a plan view of the system of FIGS. 1-4 implemented for a peg board;

FIG. 21 is a perspective plan view of the system of FIGS. 1-4 implemented for a retrofit kit;

FIG. 22 is a cross-section view of the system of FIG. 21;

FIG. 23 is a top view of the system of FIGS. 21-22;

FIG. 24 is a top plan view of the system of FIG. 1 implemented for a retrofit kit;

FIG. 25 is a cross-sectional view of the system of FIG. 24;

FIG. 26 is a side plan view of the system of FIG. 21 implemented for shelf,

FIG. 27 is a top cross-sectional view of the system of FIG. 26;

FIG. 28 is a functional block diagram of a system, according to various aspects of the present invention, that provides a carrier wirelessly and has a reader that receives through a conductor;

### DETAILED DESCRIPTION OF THE PREFERRED EMBODIMENTS

A system, according to various aspects of the present invention, identifies, tracks and/or monitors objects. A system may further perform a process in accordance with the identity of an object.

An object includes any tangible thing suitable for identifying, tracking and/or monitoring. An object includes non-electronic documents (e.g., paper files, file folders, hanging files, envelops, red rope folders), promotional material (e.g., business card, brochure, paint chip), medical records (e.g., x-rays, charts, orders, prescriptions), products (e.g., cigarettes, paint, sutures), process control material (e.g., paint chip, recipe, formula).

Identifying an object includes receiving information regarding an object, accessing information regarding objects in a database, and reporting information regarding an object. Information may include a unique identifier (e.g., unique identification number), object type, model, manufacturer, date of manufacture, description of an object, content of an object, a history of user access to the object, a use of the object, a permitted use of an object, operations performed to the object, operations performed with the object, operations performed by the object, a recipe, and a formula.

Tracking includes providing an inventory of objects, counting a number of objects, identifying objects removed from an inventory, identifying objects added and/or returned to an inventory, cataloging properties of objects, identifying a physical location of an object, and reporting an inventory. Reporting an inventory includes reporting objects in an inventory, history of an inventory, and properties of each object.

Monitoring includes identifying and tracking objects over a period of time, noting changes to properties of an object, reporting information gathered from monitoring.

A system may provide a report related to identifying, tracking, and/or monitoring objects (e.g., missing objects, periodic inventory, steps for performance of a process). A system may provide information to and/or receive information from any source (e.g., human, computer, machine) using any conventional methods of communication (e.g., keyboard entry, wired, wireless, electronic bus).

Information regarding an object may be stored in a record of a tag that is associated with the object. Information regarding an object may further be stored in a database.

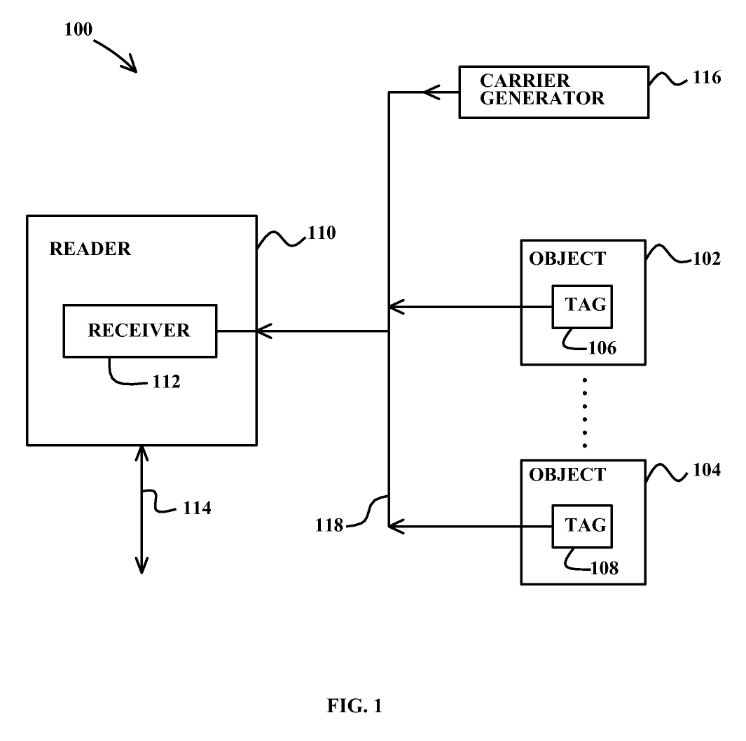

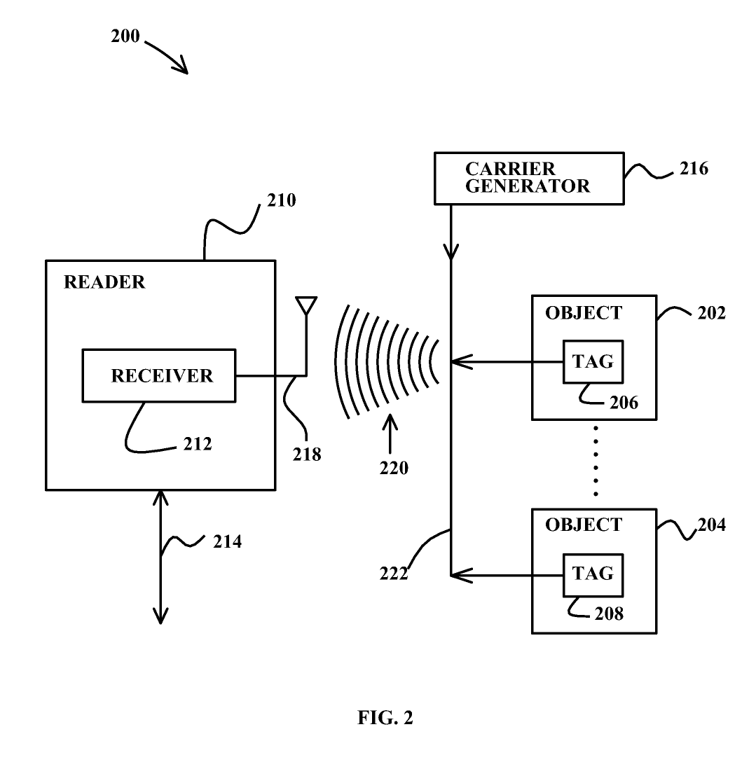

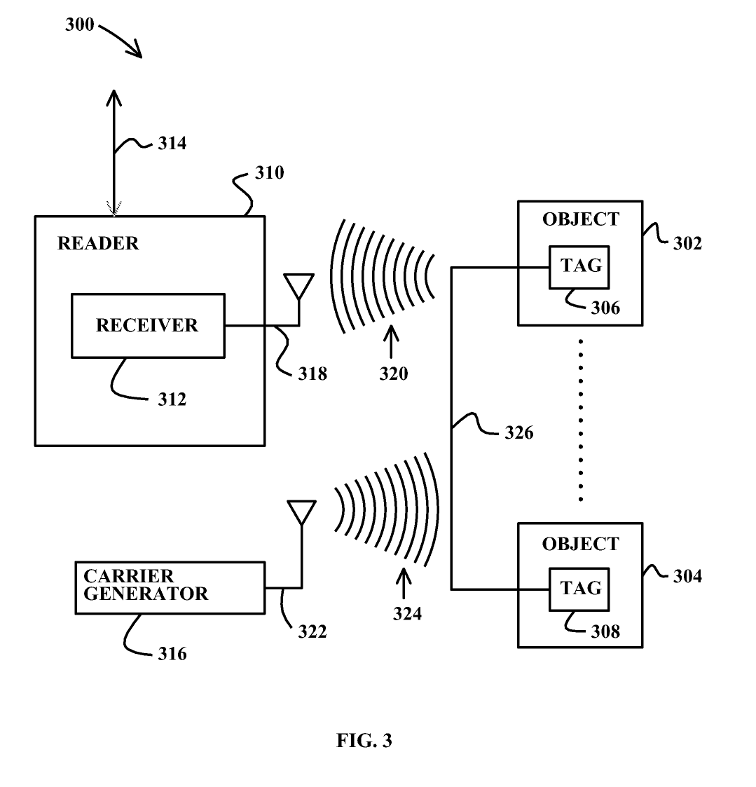

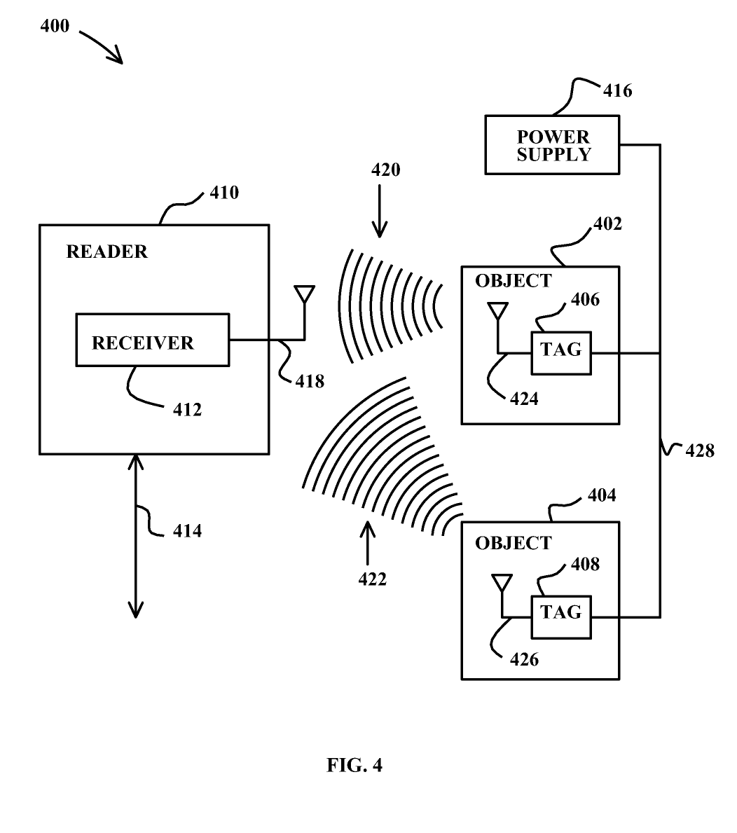

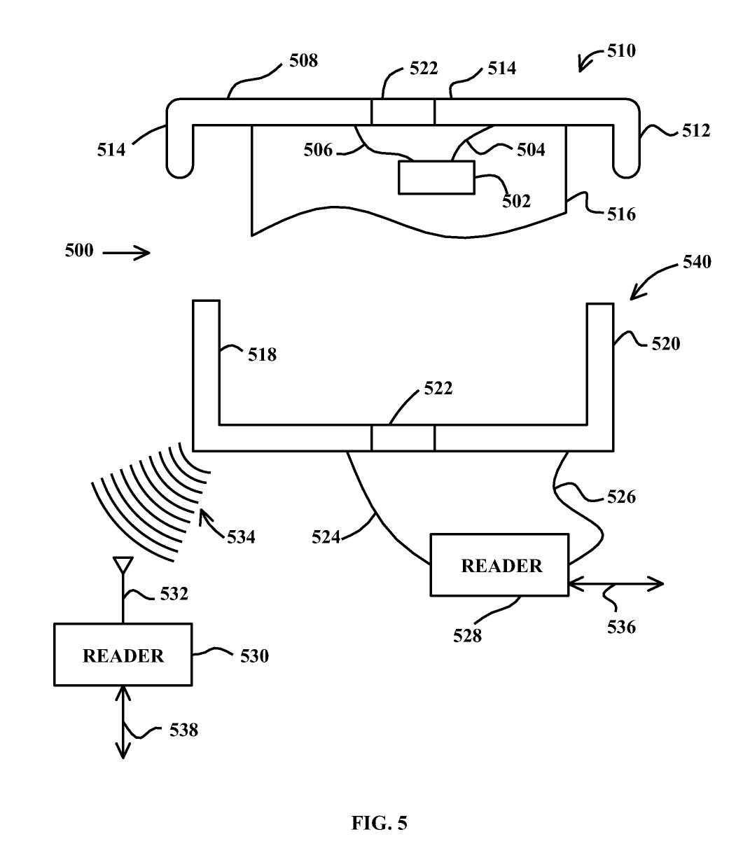

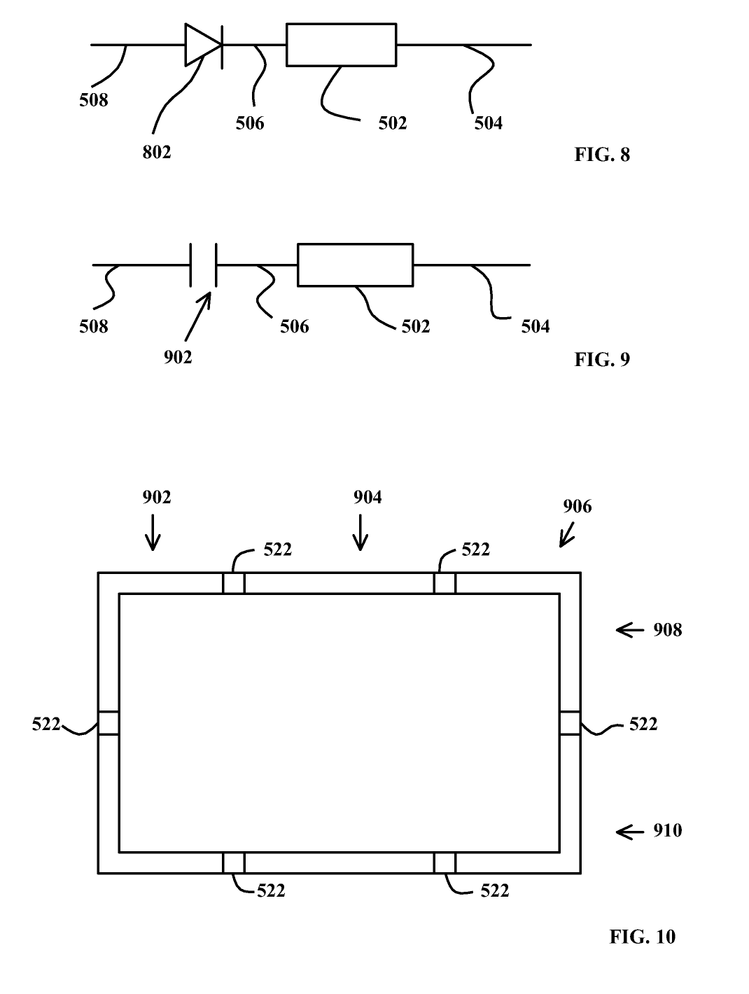

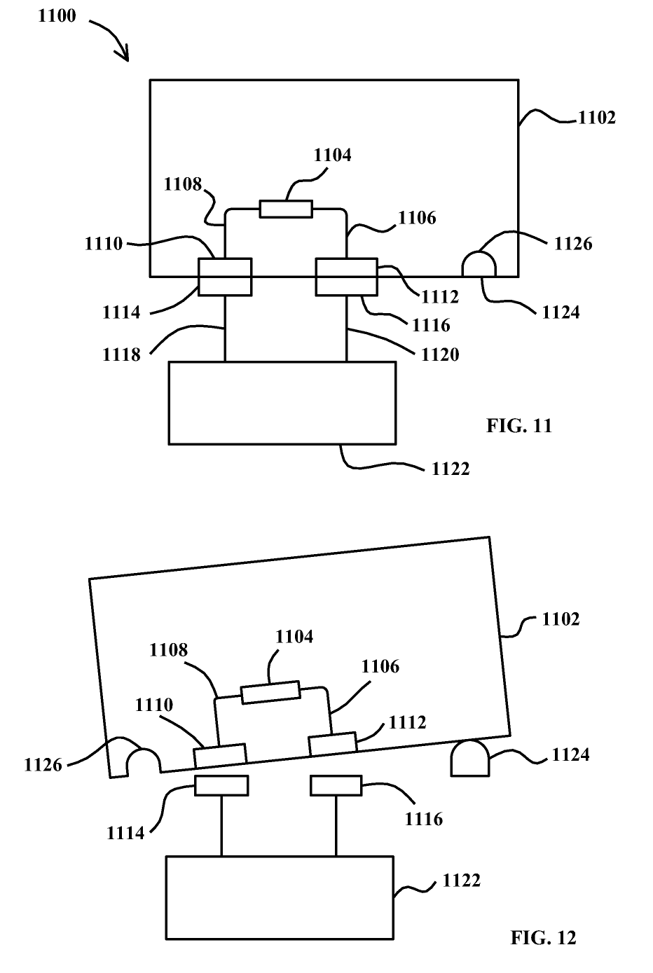

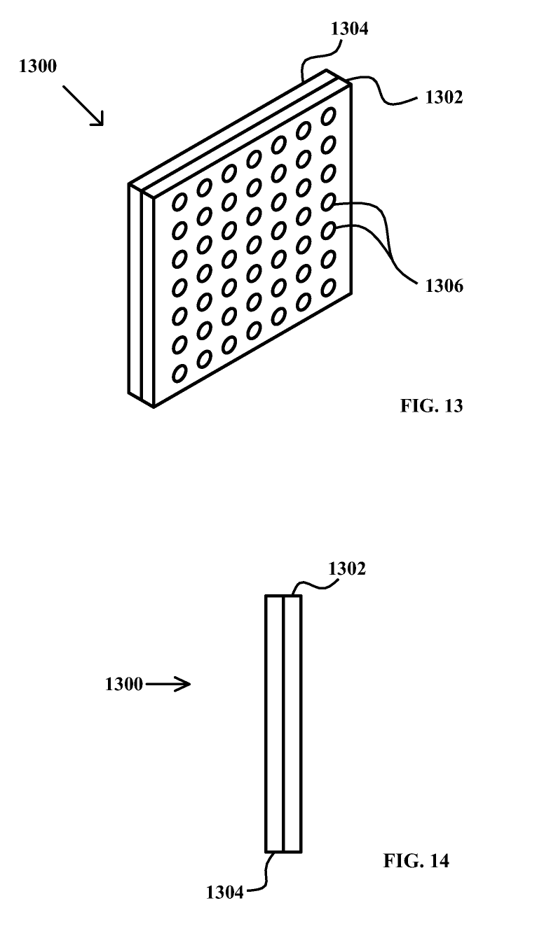

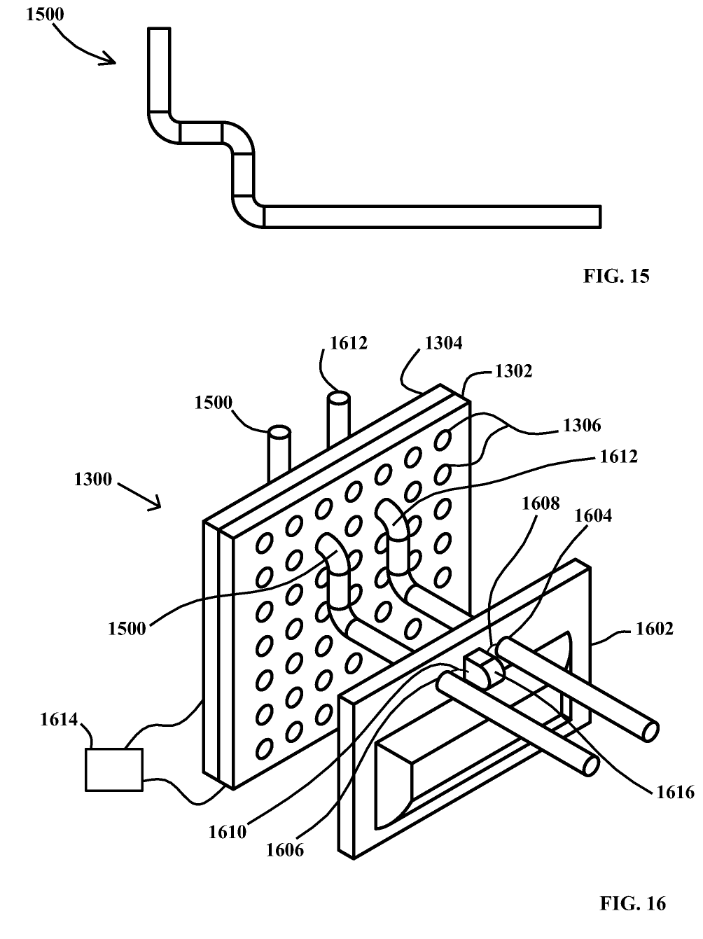

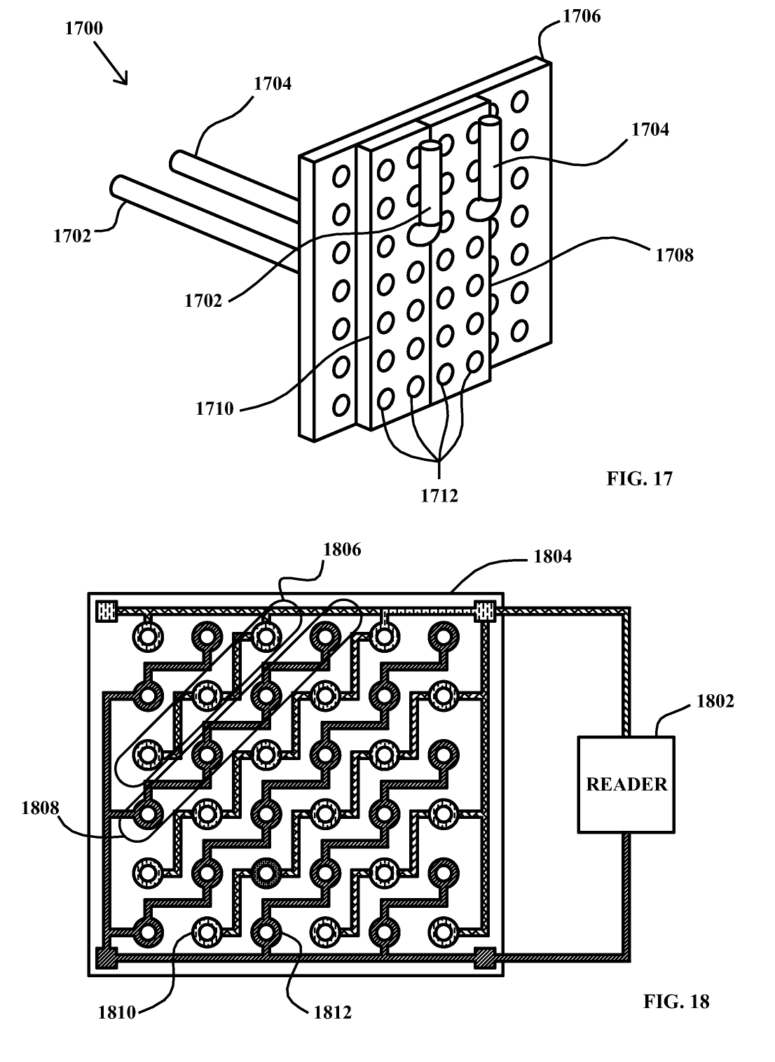

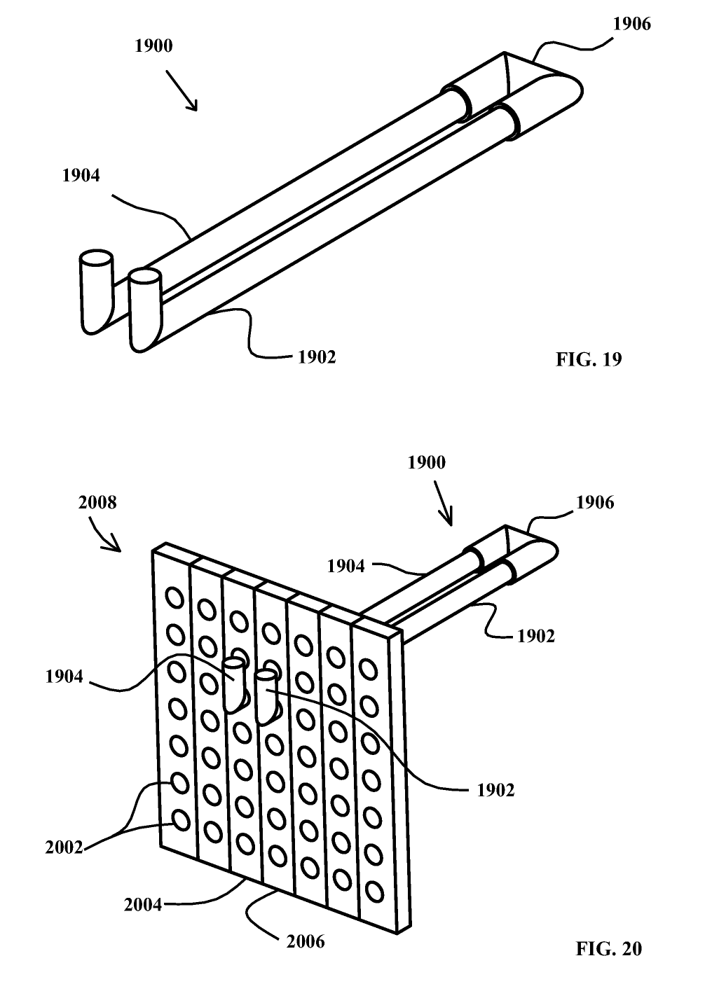

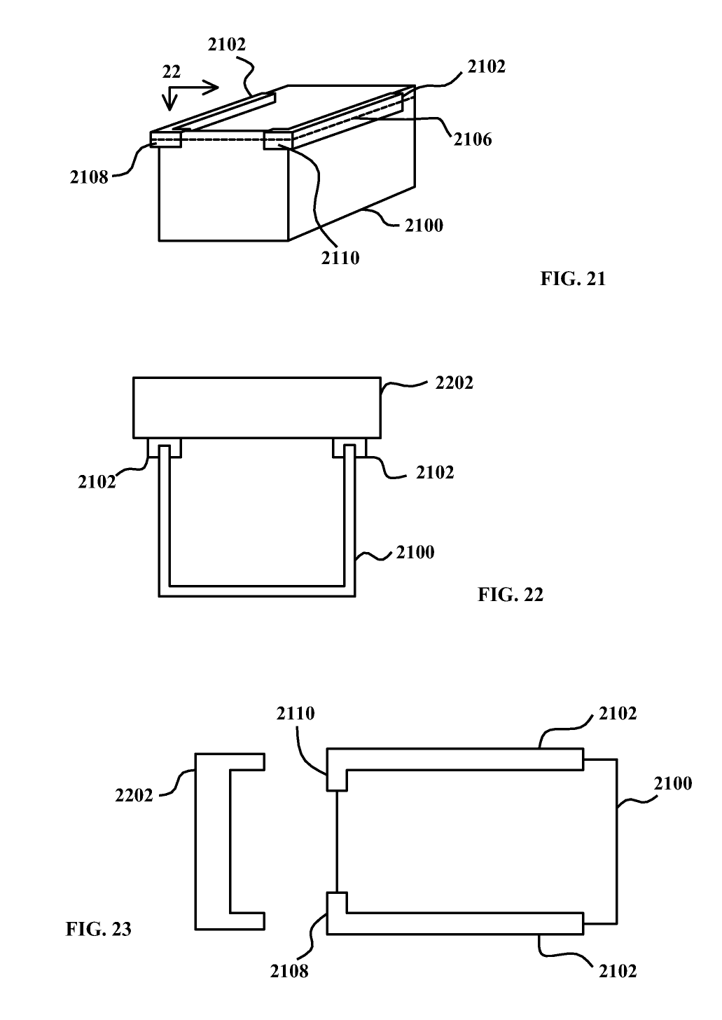

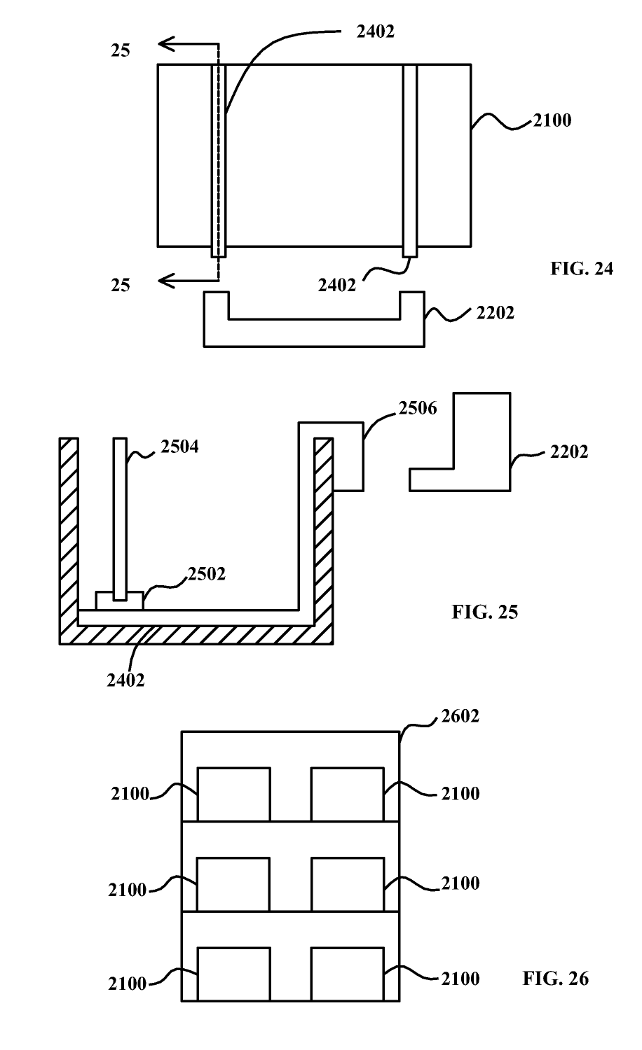

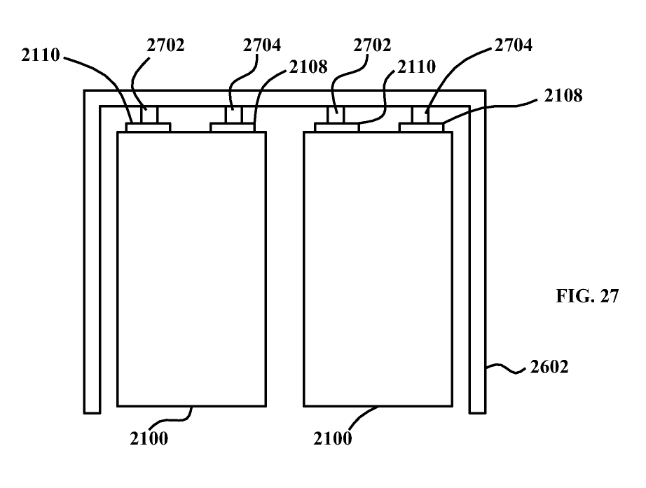

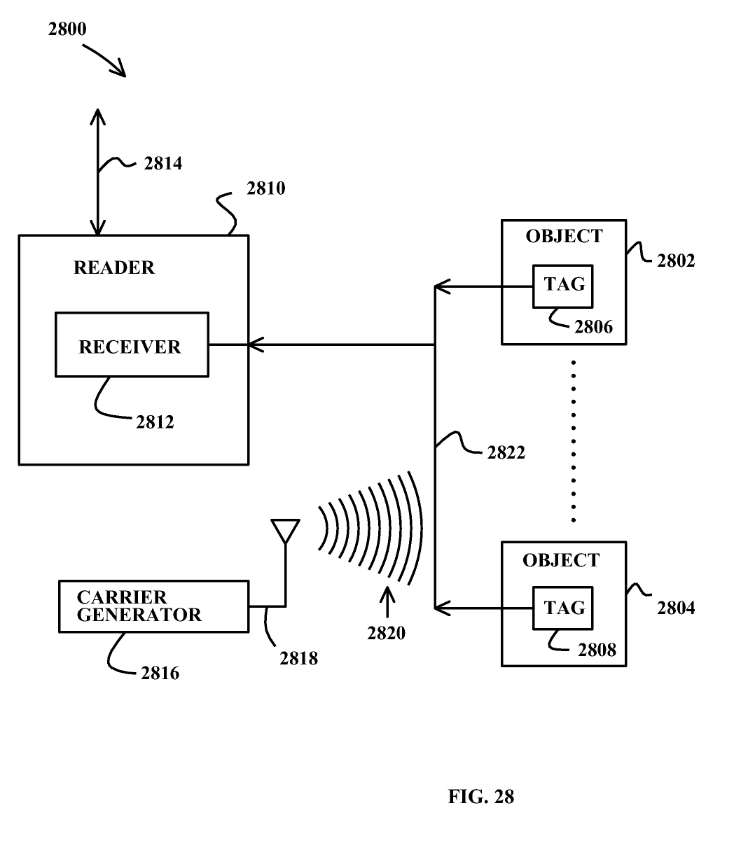

For example, systems 100, 200, 300, 400, and 2800 of FIGS. 1-28, according to various aspects of the present invention, identifies objects, tracks objects, and monitors objects.

System 100 may include reader 110, one or more tags 106-108, carrier generator 116, conductor 118, and communication link 114. Each tag 106-108 is associated with an object 102-104 respectively.

System 200 may include reader 210 having antenna 218, one or more tags 206-208, carrier generator 216, conductor 222, and communication link 214. Each tag 206-208 is associated with an object 202-204 respectively. An antenna may be omni-directional or directional.

System 300 may include reader 310 having antenna 318, one or more tags 306-308, carrier generator 316 having antenna 322, conductor 326, and communication link 314. Each tag 306-308 is associated with an object 302-304 respectively.

System 400 may include reader 410 having antenna 418, one or more tags 406-408 each one tag having respective antennas 424-426, power supply 416, conductor 428, and communication link 414. Each tag 406-408 is associated with an object 402-404 respectively.

System 2800 may include reader 2810, one or more tags 306-308, carrier generator 2816 having antenna 2818, conductor 2822, and communication link 2814. Each tag 2806-2808 is associated with an object 2802-2804 respectively.

A tag associates with an object for identifying, tracking, and/or monitoring the object. At least one tag associates with each one object. Preferably, at least one tag uniquely associates with a single object. Association of a tag with an object may include a mechanical link between the tag and the object. Preferably, a tag mechanically couples to an object. Mechanical coupling attaches a tag to an object. Mechanical coupling includes attaching with an adhesive (e.g., glue, tape, potting), positioning in a mounting structure (e.g., recess, pocket), and fastening with a fastener (e.g., bolt, screw, nail). For example, tag 106 is mechanically fastened to object 102 using an adhesive.

A tag may couple to a reader for communication. Coupling includes an electrical coupling for communication through a conductor and electromagnetic coupling for communication through an RF signal. A coupling for communication through a conductor may include a first conductor for communicating an information and a second conductor for completion of an electrical circuit between a tag and a reader. A second conductor may provide a reference signal (e.g., ground, DC voltage, DC current, AC voltage, AC current).

Communication between a tag and a reader is performed in a unidirectional manner. A reader does not send information and/or control signals to a tag. A tag does not receive information and/or control signals from a reader. A reader does not individually address (e.g., select) an individual tag. Any conventional communication protocol may be used by to provide unidirectional communication between a tag and a reader.

A tag does not communicate with any other tag. A tag does not receive information and/or control signals from any other tag. A tag does not send information and/or control signals to any other tag.

A tag may stores information. A tag may provide (e.g., communicate) an information to a reader. Information may information regarding an object as set forth above. A tag may include a media for storing and retrieving the record. A media includes any conventional memory (e.g., flash, ram, hard disk, ROM, mask programmable ROM). Storing information in a memory includes any conventional methods for writing to a memory (e.g., write to memory, mask programming of a memory in manufacture). Retrieving a record from a memory includes any conventional methods for reading data from a memory (e.g., read from memory). A memory may be a write-once, read-many memory (e.g., flash, ROM, mask programmable ROM).

A tag may receive a carrier, modulate the carrier to produced a modulated, and transmit (e.g., communicate) the modulated carrier. A tag may receive a carrier from a carrier generator. A tag may include a carrier generator as a module of the tag. A tag may include an antenna for transmitting a modulated carrier as an RF signal. A tag may provide (e.g., conduct) a modulated carrier through a conductor. A plurality of tags may couple to a conductor to modulate a carrier provided by the conductor.

A carrier generator provides a carrier. A carrier includes any waveform suitable for modulation (e.g., a voltage, a current, a waveform, a field). A carrier may be modulated to produce a modulated carrier. Modulation impresses data (e.g., indicia of information) onto a carrier. A tag may modulate a carrier in accordance with the information stored by the tag. A plurality of tags may modulate (e.g., simultaneously, at discrete times) a carrier in accordance with the respective information stored by each tag of the plurality of tags. A carrier modulated in accordance with information of a tag or a plurality of tags includes indicia of the information used to perform the modulation. An unmodulated DC and/or AC carrier does not provide information.

A method for modulating a carrier may include pulse modulation, pulse position modulation, on-off keying, loading and unloading, amplitude modulation, and power storage and active signal delivery at different frequencies.

A carrier generator may provide a carrier to a tag or a plurality of tags through a conductor and/or as an RF signal transmitted to a conductor (e.g., antenna).

A carrier generator may be a module separate from a tag and/or reader. A carrier generator may be a module of a tag. A carrier generator may be a module of a reader.

A reader may receive information from one or more tags. A reader may include a receiver for receiving a modulated carrier. A receiver may detect indicia of information in the modulated carrier. A receiver may extract indicia of information from the modulated carrier. A receiver may convert indicia of information into a form useable by a reader. A receiver may provide the information transmitted by each one tag respectively to a reader.

A receiver may receive a modulated carrier through a conductor and/or as an RF signal. A receiver may include a contact for electrically coupling to a conductor to receive the modulated carrier. A receiver may include an antenna that receives an RF signal that includes the modulated carrier.

A reader may store information received from a one or more tags. A reader may perform an operation in accordance with information received from one or more tags (e.g., execute a process in accordance with a formula provided by one or more tags). A reader may analyze information from one or more tags alone or in conjunction with other information (e.g., compare, combine, detect differences, extrapolate, search a database). A reader may provide a report regarding information received from one or more tags (e.g., objects in inventory, number of objects, age of objects). A reader may provide a warning in accordance with information received from one or more tags (e.g., missing objects, incompatibility of objects).

A reader may communicate with a device, other than tags, (e.g., keyboard, display, internet, database, computer) in a bidirectional manner. A reader may communicate information received from one or more tags to a device. A device may perform an operation, analyze information, provide reports, and provide warnings as described above. A device may provide data to a reader for performance of an operation. A reader may communicate with a device using any conventional protocol and/or technology.

A conductor conducts an electrical potential (e.g., a voltage, a current, a waveform, a field). A conductor may radiate an electrical potential as an electromagnetic field (e.g., RF signal). A conductor may coupled to signal generator (e.g., wired, wirelessly) to receive a carrier. A conductor may provide a carrier to one or more tags. One or more tags may couple to a conductor to modulate the carrier. A conductor may provide a potential to one or more tags that is not modulated by the tags, but that energizes each tag to perform an operation.

Any number of conductors may couple between any modules to complete a circuit to provide a potential to a module.

A power supply provides an electrical potential to one or more tags to energize the tags.

For example, tags 106-108 mechanically couple to objects 102 and 104 respectively. Tags 106-108 store information regarding objects 102-104 respectively. In one implementation, tags 106 and 108 store a unique identification number. Reader 110 and/or a device coupled to reader 110 via communication link 114 uses the unique identification number to index into a database that contains a property of each respectively object.

Each tag 106-108 electrically couples to first conductor 118. Carrier generator 116 couples to first conductor 118. Carrier generator 116 provides a carrier to a first conductor 118. Carrier generator 116 may further coupled to each tag 106-108 with a second conductor to complete an electrical circuit with tags 106-108.

Tags 106-108 modulate the carrier provided by carrier generator 116 to produce a modulated carrier. The carrier provided by carrier generator 116 may further provide the energy to energize tags 106-108 to modulate the carrier. Tags 106-108 may modulate the carrier simultaneously or at discrete times. In an implementation, tags 106-108 continuously modulate the carrier upon being energized. In another implementation, tags 106-108 wait a random amount of time before modulating the carrier a first time and any subsequent times. A random pause may result in a time where only one tag modulates the carrier and thereby does not collide with modulation by any other tag. In another implementation, a tag intermittently modulates the carrier. A tag may include a simple state machine (e.g., combination of electronic logic devices) to control modulation of the carrier. A tag may also include a processor (e.g., a circuit that runs a stored program) to control modulation of the carrier.

Receiver 112 of reader 110 electrically couples to first conductor 118 to receive the modulated carrier. Receiver 112 receives a modulated carrier, detects the indicia of information in the modulated carrier, extracts indicia of information from the modulated carrier, and converts the indicia of information into information from each respective tag 106-108.

In an implementation, receiver 112 mechanically and electrically couples to first conductor 118. In another implementation, receiver 112 temporarily electrically couples to first conductor 118 and subsequently temporarily electrically couples to other conductors coupled to other tags (e.g., portable reader).

In another implementation, reader 110 includes carrier generator 116. Coupling receiver 112 to first conductor 118 provides a carrier to first conductor 118 and also receives the modulated carrier from first conductor 118.

In another example, tags 206-208 mechanically couple to objects 202 and 204 respectively. Tags 206-208 store information regarding objects 102-104 respectively. In one implementation, tags 206 and 208 store a unique identification number as described above. In another implementation, tags 206-208 further store information regarding a property of objects 202 and 204 respectively. For example, if objects 202-204 were cans of base paint, tags 206-208 may store manufacture information, acceptable pigment combinations for mixing with each can of base paint, and a can serial number. Reader 210 and/or a device coupled to reader 210 via communication link 214 may use pigment combination information to control a paint tinting device to add acceptable pigments to each respective can according to customer requests. The information may also be used to provide a warning when a customer requests a pigment combination that is not acceptable for a particular can of base paint.

Each tag 206-208 electrically couples to first conductor 222. Carrier generator 216 couples to first conductor 222. Carrier generator 216 provides a carrier as described above. Tags 206-208 are energized by the carrier and modulate the carrier to produce a modulated carrier as described above. First conductor 222 radiates the modulated carrier as an electro-magnetic RF signal thereby operating as an antenna to each tag 206-208 coupled to first conductor 222.

Receiver 212 of reader 210 includes antenna 218 for receiving radiated RF signal 220 that includes the modulated carrier. Receiver 212 wirelessly receives a modulated carrier through antenna 218, detects the indicia of information in the modulated carrier, extracts indicia of information from the modulated carrier, and converts the indicia of information into information from each respective tag 206-208 in a form usable to reader 210.

In another example, tags 306-308 mechanically couple to objects 302 and 304 respectively. Tags 306-308 store information regarding objects 302-304 respectively. In one implementation, tags 306 and 308 store a unique identification number as described above. In another implementation, tags 306-308 further store information regarding a property of objects 302 and 304 respectively. For example, if objects 302-304 were lottery tickets, tags 306-308 may store information regarding the type of lottery game, instant winner information, and a card serial number. Reader 310 and/or a device coupled to reader 310 via communication link 314 may combine information from the tag with purchaser information provided at the point-of-sale to payout any winnings or to identify future winnings.

Each tag 306-308 electrically couples to first conductor 326. Carrier generator 316 does not electrically couple to first conductor 326, but wirelessly transmits a carrier to first conductor 326. Carrier generator 316 includes antenna 322 that transmits a carrier to first conductor 326 as an RF signal 324. Carrier RF signal 324 induces the carrier into first conductor 326 for modulation by tags 306-308. Tags 206-208 are energized by the carrier and modulate the carrier to produce a modulated carrier as described above. First conductor 326 radiates the modulated carrier as an electromagnetic RF signal 320 thereby operating as an antenna to each tag 306-308 coupled to first conductor 326.

Receiver 312 of reader 310 includes antenna 318 for receiving radiated RF signal 320 that includes the modulated carrier. Receiver 312 wirelessly receives a modulated carrier through antenna 318, detects the indicia of information in the modulated carrier, extracts indicia of information from the modulated carrier, and converts the indicia of information into information from each respective tag 306-308 in a form usable to reader 310.

In another example, tags 406-408 mechanically couple to objects 402 and 404 respectively. Tags 406-408 store information regarding objects 402-404 respectively. In one implementation, tags 406 and 408 store a unique identification number as described above.

Each tag 406-408 electrically couples to first conductor 428. Power supply 416 electrically couples to first conductor 428. Power supply 416 provides an electric potential that energizes tags 406-408. Power supply 416 may provide a second conductor that couples to each tag 406-408 to complete an electrical circuit.

Each tag 406-408 includes a respective carrier generator that provides a carrier for modulation. Each tag 406-408 individually modulates its respective carrier to provide a respective modulated carrier. Each tag 406-408 transmits its respective modulated carrier through respective antennas 424-426 as electromagnetic RF signals 420 and 422 respectively.

Receiver 412 of reader 410 includes antenna 418 for receiving radiated RF signals 420-422 that include respective modulated carriers. Receiver 412 wirelessly receives the respective modulated carrier through antenna 418, detects the indicia of information in the modulated carriers, extracts indicia of information from the modulated carriers, and converts the indicia of information into information from each respective tag 406-408 in a form usable to reader 410.

Reader 410 may communicate with a device via communication link 414.

In another example, tags 2806-2808 mechanically couple to objects 2802 and 2804 respectively. Tags 2806-2808 store information regarding objects 2802-2804 respectively. In one implementation, tags 2806 and 2808 store a unique identification number as described above. Each tag 2806-2808 electrically couples to first conductor 2822. Carrier generator 2816 does not electrically couple to first conductor 2822, but wirelessly transmits a carrier to first conductor 2822. Carrier generator 2816 includes antenna 2818 that transmits a carrier to first conductor 2822 as an RF signal 2820. Carrier RF signal 2820 induces the carrier into first conductor 2822 for modulation by tags 2806-2808. Tags 2806-2808 are energized by the carrier and modulate the carrier to produce a modulated carrier as described above.

Receiver 2812 of reader 2810 electrically couples to first conductor 2822 to receive the modulated carrier. Receiver 2812 receives a modulated carrier, detects the indicia of information in the modulated carrier, extracts indicia of information from the modulated carrier, and converts the indicia of information into information from each respective tag 2806-2808.

Receiver 2812 may mechanically and electrically couples to first conductor 2818 or temporarily electrically couples to first conductor 2822 as described above.

Examples of implementations, according to various aspects of the present invention, include a system for files, cards, a pegboard display, a retrofit kit, and storage of boxes.

In one implementation, a file system 500 for non-electronic documents (e.g., file, file folder, hanging file, envelop, red rope folder, x-ray folder) includes one or more readers and one or more tags. File system 500 may provide control of files, control of access to files, notification of the location of files, an index of the files located in a storage area (e.g., a filing cabinet) location and/or notice of misplaced or misfiled files, organization of files by content, and reports the contents of a file.

In one implementation, a file system includes hanging file folder 510, tag 502, reader 528 and/or 530, and conductors between tag 502 and reader 528. A file system may further include communication links 536 and 538 to another device (not shown) for readers 528 and 530 respectively.

Tag 502 mechanically couples to file folder 510. Tag 502 communicates with reader 528 through an electrical connection provided by a first conductor or with reader 530 through a wireless connection that detects an RF signal radiated by a first conductor. The first conductor includes wire 506, metallic hook 508, end portion 514 of metallic hook 508, rail 518, and wire 524. A second conductor may complete a circuit between reader 528 and tag 502. The second conductor includes wire 504, metallic hook 514, end portion 512 of metallic hook 514, rail 520, and wire 526. An electrical connection between end portion 514, rail 518 and end portion 512, rail 520 respectively may be formed while file folder 510 rests on rack 540. Rack 540 includes rail 518, rail 520, and separator 522. Separators 522 electrically separate the first conductor from the second conductor.

A file system may include one or more files. In one implementation, file system 500 includes hanging file folder 510 and 602. Documents are placed in hanging portion 516 of each hanging file folder 510 and 602. Hanging portions 516 couple to hooks (e.g., 508, 514) that hang on rack 540. In one implementation, each respective tag of each hanging file folder 510 and 602 stores a unique identification number. Reader 528 and/or reader 530 receives a unique identification number from each tag using any method described above. Reader 528 and/or reader 530 uses the unique identification number to index a database stored by the reader or by a device coupled to the readers via their respective communications links. The database contains a description of the contents of each file folder. The database, not the tag, is updated to reflect any changes in the content of any file folder.

Reader 528 may include a carrier generator to provide a carrier to tag 502 while tag 502 is electrically coupled to reader 528. A carrier generator (not shown) may also be coupled to the first conductor separate from reader 528 and/or reader 530. Reader 530 may include a carrier generator that wirelessly provides a carrier to hook 508 while hanging file folder 510 is not electrically coupled to rail 518. While hanging file folder 510 is not coupled to rail 518, reader 530 may receive an RF signal radiated by hook 508 that includes a modulated carrier.

In one implementation of file system 500, a carrier generator (not shown) provides a DC voltage potential to the first conductor and a reference voltage potential to the second conductor. The DC voltage potential energizes the tags of each hanging file folder 510 and 602. Each tag of each file folder 510 and 602 operates as a variable load (e.g., variable impedance). Variation of the load of a tag affects (e.g., perturbs, modulates) the DC voltage potential provided by the carrier generator. Each tag varies its respective impedance by shorting the DC voltage potential to the reference voltage potential and releasing the short. A tag varies its impedance in accordance with the information stored in each respective tag. Reader 528 and/or reader 530 detects the variations (e.g., perturbations, modulations) in the DC voltage potential caused by the variation of the load of each tag. The pattern of the variations is indicia of the information being sent by each tag. Any conventional encoding may be used to correlate information to variations of the DC voltage potential.

Readers 528 and/or 530 do not modulate the carrier provided to the first conductor; accordingly, the communication between tags and readers 528 and/or 530 is unidirectional.

A hanging file folder and a rail may include more than one conductor. In one implementation, hook 508 includes two conductors 600 and 602 that electrically couple to conductors 604 and 606 respectively of rail 518. Multiple conductors may be used to provide higher bandwidth and greater reliability.

A directional device protects a tag from application of an electrical potential and/or carrier that may harm the tag. In one implementation, a directional device includes diode 802. While an electric potential and/or carrier is applied to hook 508, tag 502 may perturb the electric potential and/or carrier on hook 508, but not wire 504. Accordingly, proper operation of tag 502 occurs when an electric potential and/or carrier is provided to hook 508 and not to wire 504 via hook 514.

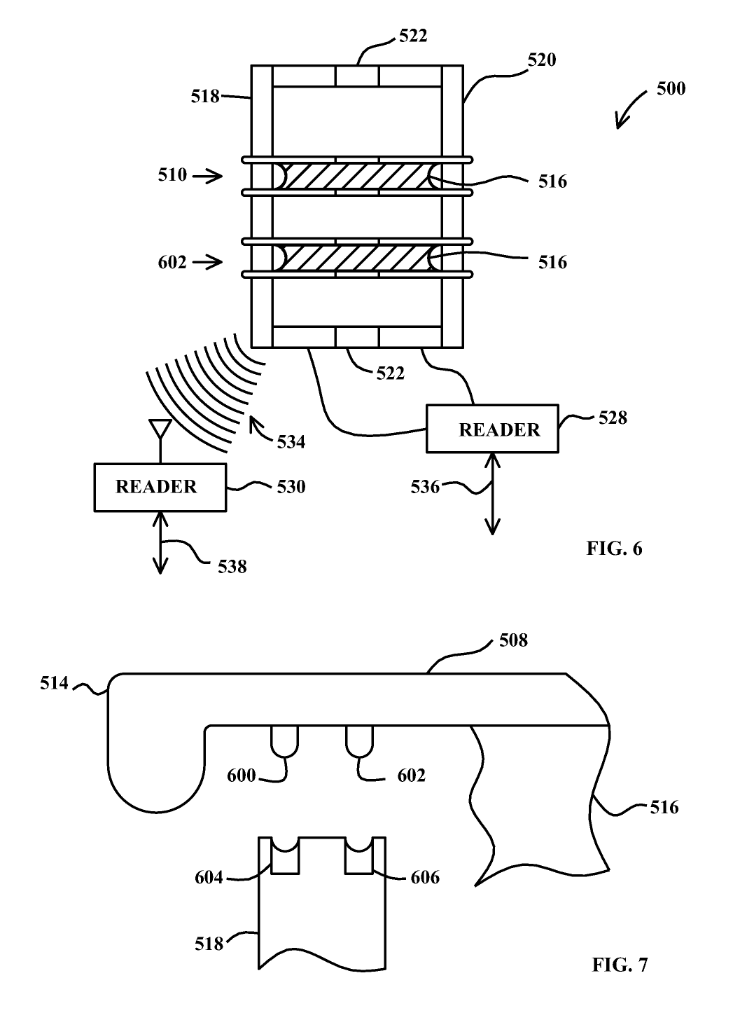

In another implementation, diode anode is coupled to hook 308 for all hanging file folders (e.g., 510, 602). When hanging file folders are placed on rack 540 (e.g., FIG. 6), hook 508 for some hanging folders may contact rail 518 while hook 508 for other hanging folders may contact rail 520. A carrier may be provided to rail 518 to receive information from the tags associated with hanging file folders whose hook 508 contacts rail 518. A carrier may be provided to rail 520 to receive information from the tags associated with hanging file folders whose hook 508 contacts rail 520.

In another implementation, a directional device includes capacitor 902. A carrier generator may provide an AC carrier to the rail that couples to hook 508 for modulation by tag 502.

As set forth above, reader 528 and/or reader 530 cannot address (e.g., select) and communicate with an individual tag to the exclusion of any other tag. Accordingly, a reader cannot command the tag to activate an indicator to provide indicia a physical location.

Indication of physical location of a tag may be provided indirectly. A reader may detect when it receives information from a particular tag (e.g., unique identification number). A system may be arranged in such a manner that a reader services a defined physical area. Accordingly, an indication from the reader of reception of information from a particular tag is also an indication of the physical location of the tag (e.g., within the defined physical area). A defined physical area may include a room, a peg board, a drawer, a shelf, a card holder, a container, and a rail pair.

A rail pair may be segmented to provide a finer granularity of physical location indication. Rails 908 and 910 may be divided into electrically separate sections 902-906 by separators 522. Each section 902-906 may be serviced by a different reader (not shown) or a reader that services multiple conductors (e.g., multiplexer). Each reader may indicate (e.g., light, sound, tactile indicators, electronic message) receipt of a particular record from one of the three sections. A rail, or any other physical location, may also be segmented to increase throughput or decrease collisions between transmissions made by a plurality of tags.

In one implementation, a system 1100 operates with cards (e.g., business card, brochure, lottery ticket, prepaid phone card, paint chip). Cards may be stored or positioned for display (e.g., bin, bins, shelves, racks, boxes). Any implementation of a reader (e.g., wired, wireless) and a signal generator (e.g., wired, wireless) or power supply may be used with cards.

For example, system 1100 includes card 1102, reader 1122 and a first conductor. A second conductor completes a circuit between reader 1122 and tag 1104. Card 1102 includes tag 1104, wires 1106-1108, and contacts 1110-1112. Reader includes reader 1122, wires 1118-1120, and contacts 1114-1116. While contact 1110 is electrically coupled to contact 1114, the first conductor, which includes wire 1108, contact 1110, contact 1114, and wire 1118, electrically couples tag 1104 to reader 1122. Likewise, while contact 1112 is electrically coupled to contact 1116, the second conductor, which includes wire 1106, contact 1112, contact 1116, and wire 1120, electrically couples tag 1104 to reader 1122. Contacts 1114 and 1116 may simultaneously contact a plurality of cards.

A card may be keyed to position contacts on the card to align with contact of the reader. For example, while guide 1124 is positioned in notch 1126, contacts 1110 and 1112 align with contacts 1114 and 1116 respectively. Alignment leads to a higher likelihood of electrical contact between contacts of the card and contacts of the reader. While guide 1124 is not positioned in notch 1126, contacts 1110 and 1112 do not electrically couple with contacts 1114 and 1116 respectively.

A contact may be positioned on a surface of an object (e.g., conductive ink, foil, metal strip) or integrated into the object. In one implementation, a conductive label is wrapped around an edge of a card to provide a contact on two sides and an edge of the card. The conductive label may be mechanically mounted to the card using an adhesive.

Contacts may be positioned on an object in such a manner that the object must be in a predetermined position for the contacts of the object to align with and electrically couple with the contacts of the reader.

In another implementation of a system for identifying, tracking, and/or monitoring objects includes a pegboard system. A pegboard system includes board 1300, hook 1500, hook 1612, product 1602, reader 1614, and a first conductor. A second conductor is provided to complete a circuit between a reader and a tag or a plurality of tags.

A board supports hooks that support objects for storage and/or display. A board positions objects for inspection and removal. A board positions hooks relative to each other. A board supports conductors. For example, board 1300 includes a plurality of holes for supporting hooks. A board has a first side 1302 and a second side 1304. A first side and a second side may be electrically separate. A first side and/or a second side may be electrically coupled to a reader.

A hook mechanically couples to a board for supporting objects for storage, display and/or access. A hook mechanically couples to an object for storing, supporting and/or displaying the object. A hook may electrically couple to a side of the board. A hook may electrically couple to a reader and an object. For example, hook 1500 inserts into a hole of board 1300. Interference of board 1300 with hook 1500 mechanically couples hook 1500 to board 1300. Hook 1500 inserts into hole 1606 of product 1602. Interference of hook 1500 with at least a portion of the circumference of hole 1606 mechanically couples hook 1500 to product 1602. Similarly, hook 1612 inserts through a hole 1306 in board 1300 and hole 1604 of product 1602. Interference between board 1300 and product 1602 with hook 1612 mechanically couples hook 1612 to board 1300 and product 1602.

In an implementation, hook 1500 electrically couples to side 1304 of board 1300 which electrically couples to reader 1614. Hook 1612 electrically couples to side 1302 which electrically couples to reader 1614. Hook 1500 and hook 1612 further electrical couple to inner circumference of holes 1606 and 1604 respectively which electrically couple to tag 1616 by wires 1610 and 1608 respectively. Accordingly, a first conductor that includes hook 1500 and side 1304 of board 1300 electrically couples reader 1614 to tag 1616. A second conductor that includes hook 1612 and side 1302 of board 1300 electrically couple reader 1614 to tag 1616.

In an implementation, hook 1702 and 1704 mechanically couple to board 1706 and conductors 1708 and 1710 respectively through holes 1712 respectively. Hooks 1702 and 1704 electrically couple to conductor 1710 and 1708 respectively. Conductors 1708 and 1710 may electrically couple to a reader. Hooks 1702 and 1704 may electrically couple to a tag of an object as described above.

In another implementation, holes of board 1804 are electrically couple in a pattern for providing electrical coupling to hooks inserted through holes of board 1804. In one implementation, holes of board 1804 are electrically couple in such a manner that adjacent holes are electrically coupled to a different conductor. For example, holes 1806 and 1810 are couple to a first conductor while holes 1808 and 1812 are couple to a second conductor. Insertion of a first hook and a second hook through holes 1810 and 1812 respectively results in an electrical connection of the first hook to the first conductor and the second hook to the second conductor. Reader 1802 electrically couples to the first conductor and the second conductor. The first hook and the second hook may also electrically couple to an object thereby completing a circuit from a tag on the product to the reader.

A first hook and a second hook may be mechanically couple, yet remain electrically separate. For example, hanger 1900 includes hook 1902 and hook 104 mechanically coupled by connector 1906. Connector 1906 electrically separates arms 1902 and 1904. Hook 1902 and 1904 mechanically couple to board 2008 through holes 2002. Hook 1902 and 1904 electrically couples to conductors 2006 and 2004 respectively. Hanger 1900 may mechanically couple to an object (not shown) while hooks 1902 and 1904 respectively electrically couple to a tag associated with the object (not shown). Conductors 2004 and 2006 may couple to a reader (not shown) thereby coupling the reader to the tags of a plurality of products electrically coupled to hanger 1900.

A user may benefit from an apparatus (e.g., retrofit kit) and/or methods that prepare an existing container (e.g., cardboard box, file drawer, filing cabinet, literature holder, business card holder, lottery card shelves) to provide electrical connectivity from a reader to objects within the container. A retrofit kit, according to various aspects of the present invention, may provide electrical signals from a tag or plurality of tags associated with objects in/on the container to a reader. A reader may be fixedly coupled to the retrofit container or a portable reader may be temporarily coupled to a retrofit container to receive records from tags of objects in/on the retrofit container.

In an implementation, a retrofit kit includes a plurality of rails 2102 and a portable reader 2202. Rails 2102 fit over the edges of the container 2100 that support the hook portion of a hanging folder. The rails contact hanging folders (not shown) having a tag. Portions of the rails, 2108, 2110 are positioned external to the container to permit contact with reader 2202. Portions 2108 and 2110 of rails 2102 are exposed below lid coverage line 2106 to permit a reader to receive records from tags associated with files inside container 2100 without opening and/or removing a lid (not shown) of container 2100. Reader 2202 may also be placed atop rails 2102 to electrically couple with the tags of the hanging folders to receive records.

Rails 2102 may have a conductive portion and an insulator portion to separate the conductive portion of rail 2102 from a conductive container. A conductive portion may include metal tape, metal that mechanically couples to a container, conductive paint, and a conductive sticker that adheres to a surface of container 2100. Rail 2102 may couple to container 2100 in any conventional manner for example friction (e.g., clipping to, detent), sticking (e.g., glue, adhesive), and attaching (e.g., staple, brad, bolt).

An implementation of a retrofit kit may accommodate files and/or cards that do not have hooks for hanging. Document 2504 mechanically couples to at least two contacts 2502. Contacts 2502 electrically couple to one rail 2402 respectively. A tag (not shown) may be associated with document 2504 and electrically coupled to contacts 2502 such that the tag electrically couples through rails 2402 to reader 2202. Contacts 2502 and rails 2402 are positioned to provide a first conductor and a second conductor that are electrically separate and electrically couple the tag to reader 2202. A portion 2506 of rail 2402 may be positioned below a lid (not shown) that may cover container 2100 thereby permitting reader 2202 to contact rails 2402 without removing the lid.

A method for retrofitting a container according to various aspects of the present invention includes applying rails to a container, placing files having a respective tag into the container in such a manner as to contact the rails, contacting the reader to the rails, receiving a record from each file.

Containers equipped with a retrofit kit may be placed into a storage area that provides electrical contact to a reader. In one implementation, shelf 2602 stores containers 2100 retrofit with rails according to various aspects of the present invention. Rails from each container 2100 electrically couple in a suitable manner to permit a reader to receive records from tags in containers stored on shelf 2602. A directional device, as described above, may be coupled to each tag to ensure that each tag may communicate with the reader regardless of orientation of container 2100. Portions 2110 and 2108 of rails on containers 2100 may electrically couple to contact 2702 and 2704 respectively. Contacts 2702 and 2704 may electrically couple to all containers 2100 placed on shelf 2602 or separate contacts may be used to electrically couple to a portion of the containers 2100. A reader couples to contacts 2702 and 2704 to electrically couple to the tags of the files in containers 2100.

A radio frequency (“RF”) identification (“ID”) reader and an RF ID tag may cooperate to provide information as to a status of a position of a door. A door may be in an opened state or a closed state. Information regarding a status of a position of a door (e.g., open, closed) may be important to a user.

An RF ID reader and an RF ID tag may be used to detect the position of a door by positioning the reader on one side of a door, positioning the tag on the other side of the door, and detecting an RF signal.

A quality of the RF signal detected by the RF ID reader and/or the RF ID tag may provide information as to the status of the position of the door. In one implementation, a door is the only entrance to an enclosure. The RF ID reader is positioned outside of the enclosure. The RF ID tag (e.g., active or passive) is positioned inside the enclosure. While the door is closed, the enclosure and the door block transmission and reception of RF signals between the RF ID reader and the RF ID tag. While the door is in a closed position, the RF ID reader does not detect an RF signal from the RF ID reader. Furthermore, when the door is closed, a passive RF Id tag does not receive the RF signal that provides energy for transmission, thus, the RF ID tag does not transmit. When the door is in an open position, the RF ID reader detects an RF signal from the RF ID tag. Furthermore, when the door is open, a passive RF ID tag receives the RF signal that provides energy and accordingly provides an RF signal to the RF ID reader which is detected by the RF ID reader through the open door.

In another implementation, the door partially blocks the RF signal and the RF ID reader detects the status of the position of the door, whether opened or closed, by detecting the strength of the RF signal. Signal strength may be detected in any manner for example, strength of radiation and detecting a pattern whose completeness depends on signal strength.

The forgoing description discussed preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A system for receiving an information from a provided object, the system comprising:
at least one tag, each one tag mechanically couples to a respective object;
a first conductor that electrically couples to each tag;
a carrier generator that electrically couples to the first conductor; and
a reader that electrically couples to the first conductor; and wherein:
each one tag stores its respective information;
the carrier generator provides a carrier to the first conductor;
each tag modulates the carrier in accordance with its respective information thereby producing a modulated carrier;
the reader receives the modulated carrier through the first conductor thereby receiving the information from each tag respectively; and
the reader does not modulate the carrier.

2. The system of claim 1 wherein the reader comprises the carrier generator.

3. The system of claim 1 wherein each one tag varies its impedance thereby modulating the carrier.

4. The system of claim 1 wherein the reader receives the information from each record from each one tag in a random order.

5. The system of claim 1 wherein the information comprises a unique identification number.

6. A system for receiving an information from a provided object, the system comprising:
at least one tag, each one tag mechanically couples to a respective object;
a first conductor that electrically couples to each tag;
a carrier generator that electrically couples to the first conductor; and
a reader having an antenna; and wherein:
each one tag stores its respective information;
the carrier generator provides a carrier to the first conductor;
each tag modulates the carrier in accordance with its respective information thereby producing a modulated carrier;
the first conductor radiates the modulated carrier as an RF signal;
the reader wirelessly receives the modulated carrier through the antenna thereby receiving the information from each tag respectively; and
the reader does not modulate the carrier.

7. The system of claim 6 wherein the reader comprises the carrier generator.

8. A system for receiving an information from a provided object, the system comprising:
at least one tag, each one tag mechanically couples to a respective object;
a first conductor that electrically couples to each tag;
a carrier generator having an antenna; and
a reader having an antenna; and wherein:
each one tag stores its respective information;
the antenna of the carrier generator transmits a carrier as an RF signal to the first conductor;
each tag modulates the carrier in accordance with its respective information thereby producing a modulated carrier;
the first conductor radiates the modulated carrier as an RF signal;
the reader wirelessly receives the modulated carrier through the antenna of the reader thereby receiving the information from each tag respectively; and
the reader does not modulate the carrier.

9. The system of claim 8 wherein the reader comprises the carrier generator.

10. A system for receiving an information from a provided object, the system comprising:
a plurality of tags, each tag having a respective antenna and a respective carrier generator that provides a respective carrier, each one tag mechanically couples to a respective object;
a power supply that provides an electric potential to the plurality of tags; and
a reader having an antenna; and wherein:
each one tag stores its respective information;
each tag modulates its respective carrier in accordance with its respective information thereby producing a respective modulated carrier;
each tag wirelessly transmits its respective modulated carrier as a respective RF signal using its respective antenna; and
the reader wirelessly receives each respective RF signal through the antenna of the reader thereby receiving the information from each tag respectively.

11. A system for receiving an information from a provided object, the system comprising:
at least one tag, each one tag mechanically couples to a respective object;
a first conductor that electrically couples to each tag;
a carrier generator that electrically couples to the first conductor; and
a reader having an antenna and a contact; and wherein:
each one tag stores its respective information;
the carrier generator provides a carrier to the first conductor;
each tag modulates the carrier in accordance with its respective information thereby producing a modulated carrier;
the first conductor radiates the modulated carrier as an RF signal;
the reader receives the modulated carrier through:
the contact while the contact is mechanically and electrically coupled to the first conductor; and
the antenna while the contact is not mechanically and electrically coupled to the first conductor; and
the reader does not modulate the carrier.

12. The system of claim 11 wherein the reader comprises the carrier generator.

13. A system for receiving an information from a provided object, the system comprising:
at least one tag, each one tag mechanically couples to a respective object;
a first conductor that electrically couples to each tag;
a carrier generator having an antenna; and
a reader that electrically couples to the first conductor; and wherein:
each one tag stores its respective information;
the antenna of the carrier generator transmits a carrier as an RF signal to the first conductor;
each tag modulates the carrier in accordance with its respective information thereby producing a modulated carrier;
the reader receives the modulated carrier through the first conductor thereby receiving the information from each tag respectively; and
the reader does not modulate the carrier.

14. A method performed by a system for transmitting a respective information from a plurality of tags to a reader, the method comprising:
providing a carrier to a first conductor;
modulating the carrier using the plurality of tags to produce a modulated carrier; and
conducting the modulated carrier through the first conductor to the reader; and wherein:
each one tag modulates the carrier in accordance with its respective information; and
each one tag electrically couples to the first conductor;

15. A method performed by a system for transmitting a respective information from a plurality of tags to a reader, the method comprising:
providing a carrier to a first conductor;
modulating the carrier using the plurality of tags to produce a modulated carrier; and
radiating the modulated carrier from the first conductor as an RF signal to the reader; and wherein
each one tag modulates the carrier in accordance with its respective information; and
each one tag electrically couples to the first conductor;
